(19) United States
(12) Patent Application Publication
(10) Pub. No.: US 2024/0236088 A1
(43) Pub. Date: Jul. 11, 2024

(54) METHOD AND ELECTRONIC SYSTEM FOR AUTHENTICATING A SUBJECT BY MEANS OF THE ASSISTANCE OF THE EYES

(71) Applicant: FOOLFARM S.P.A., Milano (IT)

(72) Inventor: Andrea CINELLI, Milano (IT)

(21) Appl. No.: 18/559,290

(22) PCT Filed: May 6, 2022
(86) PCT No.: PCT/IB2022/054206

§ 371 Date: Nov. 6, 2023

(30) Foreign Application Priority Data
May 7, 2021 (IT) 102021000011753

(51) Int. Cl. H04L 9/40

(52) U.S. Cl. CPC H04L 63/0861

(57) ABSTRACT

A method for authenticating a subject for access to a good or service by means of the assistance of the eyes is disclosed. The method uses an electronic device, a generation/authorization server device, an authentication server device and a gateway device. The authentication method comprises a first phase in which the subject is identified by means of biometric parameters associated to the eyes and a second phase in which an action is performed to confirm the intention of a request for access to the requested good or service by means of movements of the eyes.

### BACKGROUND

### Technical Field

The present disclosure generally relates to the field of the verification of a subject identity.

More in particular, the present disclosure concerns a method and electronic system for authenticating a subject for access to a good or service by means of the assistance of the eyes, for example a user of a mobile electronic device or a personal computer.

### Description of the Related Art

The authentication procedure is well known in which the identity of a subject who has been identified in a previous identification phase is verified: in the authentication phase it is verified in real time that the subject (using a smartphone or a personal computer) who wants to use a particular service is actually the subject he/she has claimed to be in the previous identification phase.

For example, the service can be to access a bank account, sign a contract remotely, or open a bank account.

Facial recognition systems for people using digital image processing techniques are known: these systems are used to authenticate a subject.

The use of strong authentication procedures is known using the combination of at least two factors of a different type to increase the level of security with which the subject is identified, in particular by using a factor known to the subject to be identified (for example, a password) and a factor associated to a physical object belonging to the user (for example, his/her face).

The Applicant has observed that the known authentication techniques of a subject have the following disadvantages:
they do not ensure that the subject to be identified is actually the subject he claims to be with sufficient certainty;
they are not sufficiently secure against cyber attacks;
they do not comply with EIDAS regulations.

### BRIEF SUMMARY

The present disclosure relates to a method and electronic system for authenticating a subject by means of the assistance of the eyes as defined in the accompanying claims 1 and 11 and from embodiments thereof described in the dependent claims 2 to 9 and 12 to 15.

The Applicant has perceived that the method and electronic system for authenticating a subject in accordance with the present disclosure have the following advantages:
they increase the certainty that the subject to be identified is actually the subject he claims to be;
they allow to obtain a medium-high level of security for the payment of a good or service, access to a confidential information file or the digital signature of a document;
they ensure service transparency with respect to the subject requesting the same service, while preserving the confidentiality of the biometric profile of the subject;
they increase security against cyber attacks;
they allow biometric recognition even if the subject is wearing a face mask;
they comply with EIDAS regulations (Electronic Identification Authentication and Signature), EU Regulation no. 910/2014.

It is also an object of the present disclosure a non-transitory computer-readable storage medium as defined in appended claim 10.

It is also an object of the present disclosure a computer program comprising instructions which, when said program is run on at least one computer, cause the computer program to perform the steps of the authentication method according to claims 1-9.

### BRIEF DESCRIPTION OF THE SEVERAL VIEWS OF THE DRAWINGS

Additional features and advantages of the disclosure will become more apparent from the description which follows of an embodiment and the variants thereof, provided by way of example with reference to the appended drawings, wherein:

FIG. 1 shows a block diagram of an electronic system for authenticating a subject by means of the assistance of the eyes according to the disclosure;

FIGS. 2A-2B show a time trend of the messages exchanged among the different components of the electronic authentication system according to the disclosure.

### DETAILED DESCRIPTION

It should be noted that in the description below, identical or similar blocks, components or modules, even if they appear in different embodiments of the disclosure, are indicated by the same numerical references in the figures.

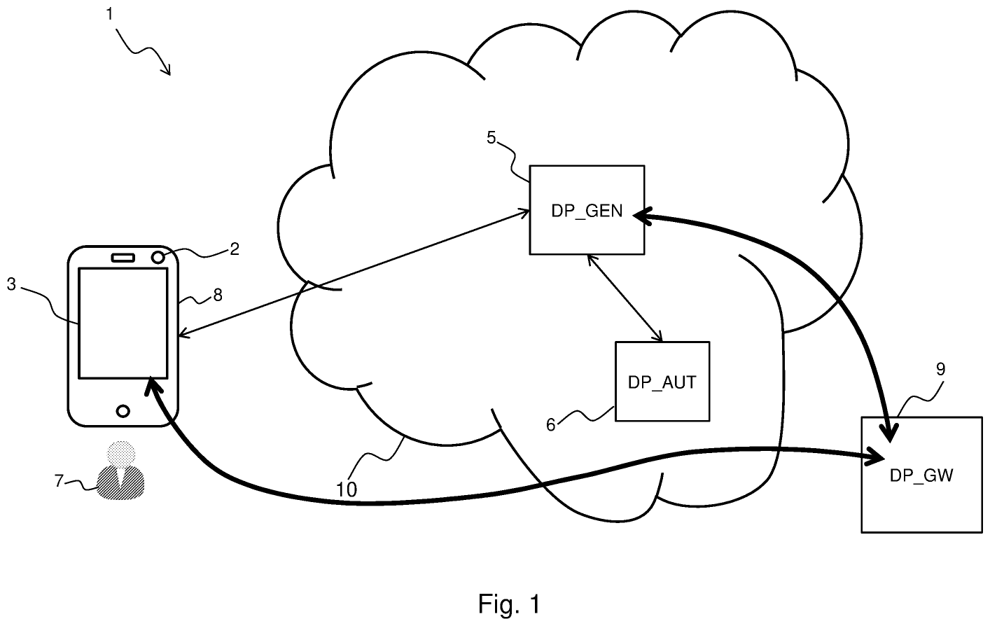

With reference to FIG. 1, an electronic system 1 is shown for authenticating a subject 7 for access to a good or service by means of the assistance of the eyes according to the disclosure.

The electronic authentication system 1 comprises an electronic device 8, a generation/authorisation server device 5, an authentication server device 6 and a gateway device 9, which are connected by means of a medium-long distance telecommunications network 10, for example the Internet network which uses the TCP/IP protocol, with a client-server architecture and use of Web Services.

The generation/authorisation server device 5 is included within the telecommunications network 10, while the authentication server device 6 and the gateway device 9 can be positioned outside the network 10 or therein.

In one embodiment, the electronic authentication system 1 comprises (alternatively or in addition to the gateway device 9) an external service provider, if the service requested by the subject 7 is not delivered by the gateway device 9, but it is delivered by the external provider.

The use of a separate gateway device 9 (and/or the external service provider) from the authentication server device 6 has the advantage of reducing the risk that the ocular biometric profile of the subject 7 can be stolen by a person other than the subject 7.

A subject 7 uses the electronic authentication system 1 to request the authorisation to access a certain good or service using the eyes and/or the head and without using the hands: the subject 7 (who is supposed to have already been previously identified by means of a profiling procedure) is first recognised by means of biometric parameters associated to his/her eyes and then he confirms the intention to request access to a good or service by means of an appropriate movement of his/her eyes and/or by means of a gesture of at least a part of the body (for example, a movement of the head), as will be explained in more detail below.

The good or service for which the subject 7 requests access can be, for example:
the payment of a good or service, such as the purchase of a book in digital format, the purchase of a financial product, the purchase of a food;
the access to a confidential information file;
the access to the balance of a bank account;
the digital signature of a document;
a booking of a medical examination;
the booking of a holiday;
the control of an electro-mechanical actuator, for example the opening of an access door, the opening an automatic gate, the ignition of a motor vehicle.

The electronic device 8 belongs to the subject 7 and it can be a fixed type (for example, a personal computer or a totem) or a mobile type (for example, a smartphone, tablet or laptop computer).

The electronic device 8 comprises a speaker, a microphone, a camera 2 and a long-distance signal transceiver.

The electronic device 8 has the function of acquiring in real time, by means of the camera 2 and during a first phase of the authentication procedure of the disclosure, one or more images representative of at least one portion of the face of the subject 7, wherein said portion of the face comprises the eyes of the subject 7: said images will be used by the generation/authorisation server device 5 to identify at least one ocular biometric parameter of the subject 7 and to generate therefrom a sample ocular code, which in turn will be used by the authentication device 6 to identify the subject 7 requesting access to a good or service.

The transceiver of the electronic device 8 is such to transmit/receive wired signals or medium-long distance wireless signals.

In particular, the transceiver of the electronic device 8 is configured to transmit, towards the generation/authorisation server device 5, the plurality of acquired images representative of at least one portion of the face comprising the eyes of the subject 7 and a message carrying a plurality of images representative of a movement of the eyes indicative of a positive or negative intention of a request for access to a good or service.

Furthermore, the transceiver of the electronic device 8 is configured to receive from the generation/authorisation server device 5 a message indicative of a performed verification of the identity of the subject 7, and it is configured to receive from the gateway device 9 a request for confirmation of the intention to access the requested good or service.

Furthermore, the transceiver of the electronic device 8 is configured to receive, from the gateway device 9 or from the external service device, a message indicative of a confirmation of the delivery of the requested good or service.

Furthermore, the electronic device 8 has the function of acquiring in real time, by means of the camera 2 and during a second phase of the authentication procedure of the disclosure, a plurality of images representative of at least one movement of the eyes of the subject 7, wherein said movement of the eyes will be used to confirm or to deny the intention of a request for access to a good or service by the subject 7.

Some examples of movements of the eyes requested from the subject 7 in real time are as follows:
moving the eyes towards the right-side edge or left-side edge of a screen observed by the subject 7 (for example, the screen 3 of a smartphone 8) to confirm or reject, respectively, the intention of the request for access to the good or service, or vice versa;
tracking with the eyes a light signal (for example, a light point) moving along a screen observed by the subject 7 (for example, the screen 3 of the smartphone 8) to confirm the intention of the request for access to the good or service, wherein the light signal moves along a path defining for example a line or a particular geometric shape (a rectangle, a circle, a shape of a letter Z).

Alternatively (or in combination with the movement of the eyes), the electronic device 8 has the function of acquiring in real time, by means of the camera 2 and during the second phase of the authentication procedure according to the disclosure, a further plurality of images representative of a gesture of at least one part of the body of the subject 7, such as for example a movement of the head such as a tilting or a rotation of the head, wherein said gesture of the body will be used (in combination or as an alternative to the movement of the eyes) to confirm or to deny the intention of a request for access to a good or service by the subject 7.

Some examples of gestures requested from the subject 7 are as follows:
touching the right (or left) side of the forehead with a finger of one hand;
touching the right (or left) side of the forehead with two fingers of one hand;
touching the right (or left) side of the forehead with three or more fingers of one hand;
tilting the head towards the right;
tilting the head towards the left;
rotating the head in a clockwise direction;
rotating of the head in a counterclockwise direction.

According to another alternative embodiment of the disclosure, said movement of the eyes is a sequence of one or more movements of the eyes of the subject 7 defined in advance and it will be indicated hereinafter by “sample movement of the eyes”, which is thus a sequence of movements of the eyes which are chosen in advance by the subject 7 himself/herself.

Some examples of sample movements of the eyes (i.e., chosen in advance by the subject 7) are as follows, wherein it is assumed for the sake of simplicity to start with the pupil in a central position with respect to the eye:
a movement of the pupil upwards or downwards;
a movement of the pupil upwards followed by a movement of the pupil downwards, or vice versa;
a movement of the pupil to the right or to the left;
a movement of the pupil to the right followed by a movement of the pupil to the left, or vice versa;
a diagonal movement of the pupil, to the right or to the left;
a diagonal movement of the pupil to the right followed by a movement of the pupil to the left;
a combination of three or four pupil movements selected from the following, in different orders: movement upwards, movement downwards, movement to the right, movement to the left, diagonal movement to the right, diagonal movement to the left.

It is assumed that the subject 7 has already been identified in a previous profiling procedure in a secure condition, wherein personal data of the subject has been acquired, such as his/her name, surname, telephone number, identity card.

During the profiling procedure, a unique identifier of the subject 7 was associated to the electronic device 8.

For example, the electronic device 8 is a smartphone provided with a SIM card and therefore the unique identifier of the subject 7 is the phone number associated to the SIM card.

Furthermore, during the profiling procedure a photo of the eyes of the subject 7 is taken by means of a camera (for example, by means of a front camera 2 of a smartphone 8) and then a image representative of the eyes of the subject 7 is acquired, then a reference ocular code of the subject 7 is generated (by means of a suitable algorithm) as a function of at least one parameter associated to the eyes of the subject 7.

The term “reference ocular code” is intended as a reference ocular profile representative of the digital identity of the subject 7, wherein said reference ocular profile is a unique code which is generated as a function of at least one biometric parameter of the eyes of the subject 7, by means of a suitable algorithm which takes as input one or more parameters associated to the eyes of the subject 7.

The reference ocular code of the subject 7 has been previously generated securely in a profiling procedure by means of the generation/authorisation server device 5 and sent to the authentication server device 6, and wherein said reference ocular code has been stored in a memory 6-1 internal or external to the authentication server device 6: the reference ocular code has therefore been previously verified and it is considered reliable.

In one embodiment, the reference ocular code is also stored in a further backup memory: thereby in the event of failure of the memory 6-1, it is possible to recover the data of the reference ocular code from the backup memory.

In particular, during the profiling procedure at least one of the ocular parameters of the subject 7 indicated above is acquired, or selected from the following list:
colour of the iris of the eyes of the subject 7;
colour of the sclera of the eyes of the subject 7;
colour of the cornea of the eyes of the subject 7;
diameter of the eyes of the subject 7;
distance of the pupil from the inner corner of the eye;
distance of the pupil from the outer corner of the eye;
size and shape of the eyebrows (in particular, the starting and ending point, the shape of the curvature).

Subsequently, the reference ocular code is generated based on a suitable algorithm, which receives as input at least one of the biometric parameters of the eyes indicated above and generates as output a unique code which can be represented in alphanumeric format (i.e., a token), by means of a suitable function.

The reference ocular code is for example implemented with a hash code which receives as input one or more biometric parameters of the eyes of the subject 7 and generates as output (by means of a suitable function) said unique code.

In one embodiment, the reference ocular code is generated as a function of two parameters chosen from the colour of the cornea, the colour of the iris, the colour of the sclera and the diameter of the eye.

Alternatively, the reference ocular code is generated according to three parameters chosen from the colour of the cornea, the colour of the iris, the colour of the sclera and the diameter of the eye.

Alternatively, the reference ocular code is generated as a function of the colour of the cornea, colour of the iris, colour of the sclera and diameter of the eye.

According to an embodiment of the disclosure, during the profiling procedure a movement of the eyes of the subject 7 is defined, which will be indicated below with reference movement of the eyes.

The term “reference movement of the eyes” is intended as a sequence of one or more defined movements of the eyes of the subject 7 indicated above, i.e., a sequence of movements of the eyes which are chosen by the subject 7 himself/herself.

Some examples of reference movements of the eyes are as follows, wherein it is assumed for the sake of simplicity to start with the pupil in a central position with respect to the eye:
a movement of the pupil upwards or downwards;
a movement of the pupil upwards followed by a movement of the pupil downwards, or vice versa;
a movement of the pupil to the right or to the left;
a movement of the pupil to the right followed by a movement of the pupil to the left, or vice versa;
a diagonal movement of the pupil, to the right or to the left;
a diagonal movement of the pupil to the right followed by a movement of the pupil to the left;
a combination of three or four pupil movements selected from the following, in different orders: movement upwards, movement downwards, movement to the right, movement to the left, diagonal movement to the right, diagonal movement to the left.

In one embodiment, during the profiling procedure a movement of the head is further defined (in addition or as an alternative to the movement of the eyes), which will be indicated hereinafter with “reference movement of the head”.

Some examples of reference movements of the head are as follows:
a tilting of the head towards the right;
a tilting the head towards the left;
a rotation of the head in a clockwise direction;
a rotation of the head in a counterclockwise direction.

In one embodiment, during the profiling procedure a reference voice profile of the subject 7 is generated, in addition to the reference ocular code of the subject 7.

According to an embodiment, the reference ocular code of the subject 7 is stored in a data structure of a blockchain.

The generation/authorisation server device 5 is an electronic device comprising a transceiver for exchanging data with the electronic device 8, with the authentication server device 6 and with the gateway device 9.

The generation/authorisation server device 5 further comprises a processing unit (for example, a microprocessor) running a software program to perform the functions which will be illustrated below.

The generation/authorisation server device 5 has the function of generating a sample ocular code of the subject 7 in real time, which will subsequently be used by the authentication server device 6 to authenticate a subject 7 in order to allow or deny access to a good or service requested by the subject 7 with the assistance of the eyes.

The term “sample ocular code” is intended as a sample ocular profile representative of the digital identity of the subject 7, wherein said sample reference ocular profile is a unique code which is generated as a function of at least one biometric parameter of the eyes of the subject 7, by means of a suitable algorithm which takes as input one or more parameters associated to the eyes of the subject 7.

The ocular biometric parameters of the subject 7 are acquired in real time by means of a camera, for example by means of a camera 2 integrated in the electronic device 8.

Therefore the ocular biometric parameters used to generate the sample ocular code are acquired at a different instant from the ocular biometric parameters used to generate the reference ocular code.

In particular, the ocular biometric parameters used to generate the sample ocular code in the first phase are at least one parameter selected from the following list:
colour of the iris of the eyes of the subject 7;
colour of the sclera of the eyes of the subject 7;
colour of the cornea of the eyes of the subject 7;
diameter of the eyes of the subject 7;
distance of the pupil from the inner corner of the eye of the subject 7;
distance of the pupil from the outer corner of the eye of the subject 7;
size and shape of the eyebrows of the subject 7 (in particular, the starting and ending point, the shape of the curvature).

The sample ocular code is generated based on a suitable algorithm, which receives as input at least one of the biometric parameters of the eyes indicated above and generates as output a unique code which can be represented in alphanumeric format (i.e., a token), by means of a suitable function.

The sample ocular code is for example implemented with a hash code which receives as input one or more biometric parameters of the eyes of the subject 7 and generates as output (by means of a suitable function) said unique code.

In one embodiment, the sample ocular code is generated as a function of two parameters chosen from the colour of the cornea, the colour of the iris, the colour of the sclera and the diameter of the eye.

Alternatively, the sample ocular code is generated as a function of three parameters chosen from the colour of the cornea, the colour of the iris, the colour of the sclera and the diameter of the eye.

Alternatively, the sample ocular code is generated as a function of the colour of the cornea, colour of the iris, colour of the sclera and diameter of the eye.

It is clear that the same ocular biometric parameters and the same function or algorithm are used to generate the sample ocular code and the reference ocular code.

The generation/authorisation server device 5 further has the function of authorising or denying the request for access to the good or service of the subject 7, by comparing a sample movement of the eyes of the subject 7 (acquired in real time) and a reference movement of the eyes of the subject 7 (defined in advance in a profiling procedure in secure conditions), or by verifying a defined movement of the eyes of the subject 7, or by recognising a defined movement of at least a part of the body of the subject 7 (for example, the tilting or rotation of the head of the subject 7).

In one embodiment, the generation/authorisation server device 5 is configured to authorise or deny the request for access to the good or service of the subject 7, by means of the comparison between the sample movement of the eyes of the subject 7 and the reference movement of the eyes of the subject 7 and by means of the comparison between a sample movement of the head of the subject 7 (acquired in real time) and a reference movement of the head of the subject 7 (defined in advance in the profiling procedure).

In particular, during a first phase of the authentication procedure of the disclosure the generation/authorisation server device 5 is configured to receive, from the electronic device 8, a plurality of acquired images representative of at least one portion of the face comprising the eyes of the subject 7, then the processing unit of the generation/authorisation server device 5 is configured to appropriately process the acquired images and identify therefrom at least one ocular biometric parameter associated to the eyes of the subject 7, identifying the same ocular biometric parameters used for the reference ocular code of the subject 7.

Furthermore, during the first phase the generation/authorisation server device 5 is configured to generate the sample ocular code of the subject 7 in real time as a function of the at least one identified ocular biometric parameter of the subject 7, by means of the same generation algorithm used to generate the reference ocular code of the subject 7.

Furthermore, during the first phase, the generation/authorisation server device 5 is configured to transmit, towards the authentication server device 6, a message carrying the value of the sample ocular code, and it is configured to receive, from the authentication server device 6, a message indicative of a positive or negative confirmation of the digital identity of the subject 7.

In the second phase of the authentication procedure, the generation/authorisation server device 5 is configured to receive, from the electronic device 8, a plurality of images representative of a movement of the eyes of the subject 7, it is configured to analyse said plurality of received images representative of the movement of the eyes of the subject 7, it is configured to identify a sample movement of the eyes as a function of said plurality of received images representative of the movement of the eyes of the subject 7, it is configured to read from the memory 5-1 the reference movement of the eyes of the subject 7 and it is configured to perform a comparison between the sample movement of the eyes of the subject 7 and the reference movement of the eyes of the subject 7:
in the event of a positive comparison (i.e., the sample movement of the eyes is equal to the reference movement of the eyes), the generation/authorisation server device 5 transmits towards the gateway device 9 a message indicative of an authorisation granted to the request for access to the good or service of the subject 7, i.e., this has been successfully identified;
in the event of a negative comparison (i.e., the sample movement of the eyes is different from the reference movement of the eyes), the generation/authorisation server device 5 transmits towards the gateway device 9 an authorisation denied message to the request for access to the good or service of the subject 7, i.e., this has not been successfully identified.

Alternatively, in the second phase of the authentication procedure, the generation/authorisation server device 5 is configured to receive, from the electronic device 8, a plurality of images representative of a movement of the eyes of the subject 7, is configured to identify said movement of the eyes as a function of said plurality of images received and is configured to transmit, towards the gateway device 9, a message indicative of an authorisation granted or denied to the request for access to the good or service of the subject 7, based on the type of identified movement of the eyes.

In one embodiment, in the second phase of the authentication procedure, the generation/authorisation server device 5 is configured to receive, from the electronic device 8, a further plurality of images representative of a movement of the head of the subject 7, it is configured to analyse said plurality of received images representative of the movement of the eyes of the subject 7, it is configured to identify a sample movement of the head as a function of said further plurality of received images representative of the movement of the head of the subject 7, it is configured to read from the memory 5-1 the reference movement of the head of the subject 7 and it is configured to perform a comparison between the sample movement of the head of the subject 7 and the reference movement of the head of the subject 7:
in the event of a positive comparison (i.e., the sample movement of the head is equal to the reference movement of the head), the generation/authorisation server device 5 transmits towards the gateway device 9 a message indicative of an authorisation granted to the request for access to the good or service of the subject 7, i.e. this has been successfully identified;
in the event of a negative comparison (i.e., the sample movement of the head is different from the reference movement of the head), the generation/authorisation server device 5 transmits towards the gateway device 9 an authorisation denied message to the request for access to the good or service of the subject 7, i.e. this has not been successfully identified.

Alternatively, in the second phase of the authentication procedure the generation/authorisation server device 5 is configured to receive, from the electronic device 8, a plurality of images representative of a movement of the head of the subject 7, it is configured to identify said movement of the head as a function of said plurality of images received and it is configured to transmit, towards the gateway device 9, a message indicative of an authorisation granted or denied to the request for access to the good or service of the subject 7, based on the type of identified movement of the head.

The authentication server device 6 has the function of performing (together with the generation/authorisation server device 5) a profiling of the subject 7 during a profiling procedure (prior to the phase of the normal operation of the electronic authentication system 1) which occurs in a condition of maximum security, during which personal data of the subject (such as his/her name, surname, telephone number, identity card), ocular biometric parameters of the subject 7 and possibly biometric parameters of the voice type of the subject 7 are acquired.

The authentication server device 6 is connected to a non-volatile memory 6-1 (internal or external) configured to store a reference ocular code of the subject 7 and possibly a reference voice profile of the subject 7.

The authentication server device 6 further has the function of authenticating the subject 7 (i.e., verifying his/her digital identity) by means of a comparison between the sample ocular code of the subject 7 (generated in real time by means of the electronic device 8) and the reference ocular code of the subject 7.

In particular, during the first phase of the authentication procedure according to the disclosure, the authentication server device 6 is configured to receive, from the generation/authorisation server device 5, a message carrying the value of the sample ocular code, it is configured to read from the memory 6-1 the value of the reference ocular code and it is configured to perform a comparison between the value of the sample ocular code and the value of the reference ocular code:
in the event of a positive comparison (i.e., the value of the sample ocular code is equal to the value of the reference ocular code), the transceiver of the authentication server device 6 is configured to transmit, towards the generation/authorisation server device 5, a message indicative of a positive confirmation of the identity of the subject 7, i.e., the identity of the subject 7 has been successfully verified;
in the event of a negative comparison (i.e., the value of the sample ocular code is different from the value of the reference ocular code), the transceiver of the authentication server device 6 is configured to transmit, towards the generation/authorisation server device 5, a message indicative of a negative confirmation of the identity of the subject 7, i.e., the identity of the subject 7 has not been successfully verified.

The gateway device 9 is an electronic device comprising a transceiver for exchanging data with the generation/authorisation server device 5 and with the electronic device 8 and further comprises a processing unit (for example, a microprocessor) running a software program to perform the functions which will be illustrated below.

The gateway device 9 is a gateway towards third parties which request authentication; in particular, the gateway device 9 has the function of verifying the availability of a good or service requested by the subject 7, and of confirming or denying the delivery of the requested good or service.

For example, the gateway device 9 is a payment gateway which is located at a third party which manages payment systems, for example at a financial institution or a bank: in this case the gateway device 9 has the function of managing the payment of the requested good or service.

In particular, during the second phase of the authentication procedure according to the disclosure, the gateway device 9 is configured to receive, from the electronic device 8, a message indicative of a request for access to a good or service requested by the subject 7, then the gateway device 9 is configured to transmit towards the electronic device 8 a message indicative of a request for confirmation of the intention to access the requested good or service.

Furthermore, during the second phase, the gateway device 9 is configured to receive, from the generation/authorisation server device 5, a message indicative of an authorisation granted or denied to the request for access to the good or service requested by the subject 7:
in the event of receipt of the granted authorisation, the gateway device 9 is configured to transmit, towards the electronic device 8, a message indicative of a confirmation of delivery of the requested good or service;
in the event of receipt of a denied authorisation, the gateway device 9 is configured to transmit, towards the electronic device 8, a message indicative of a refusal to deliver the requested good or service.

It should be noted that the presence of the electronic device 8 is not essential, i.e., the presence of a camera 2 capable of acquiring the parameters of the eyes indicated above is sufficient, wherein the camera can for example be installed on a fixed station in which the identification of the subject 7 is performed.

It should also be noted that the subject 7 may also not be of the human type, i.e., it is possible that the subject 7 is a robot with a humanoid appearance and capable of replicating biometric features of the eyes of a human (for example, using cameras to create the eyes), so that it is possible to associate one or more identifying parameters of the ocular biometric features of the humanoid robot.

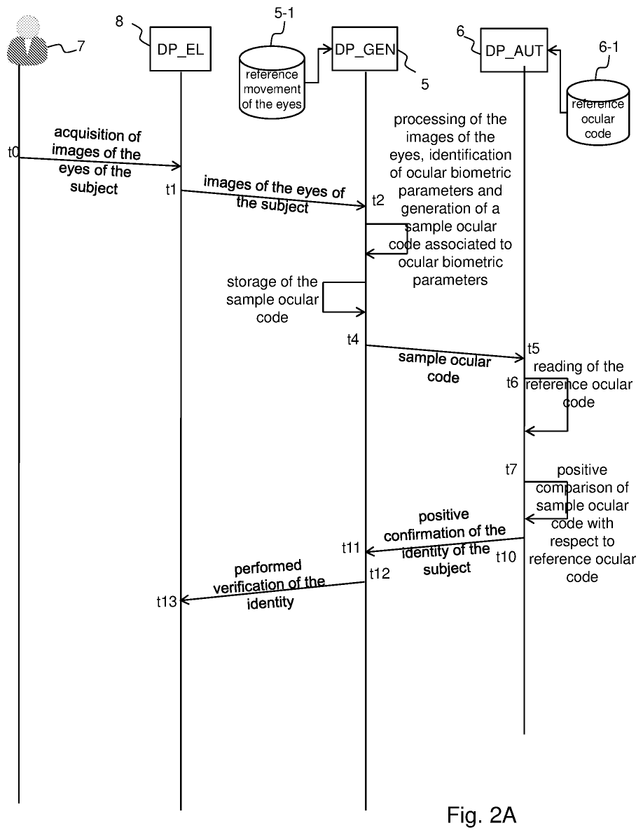

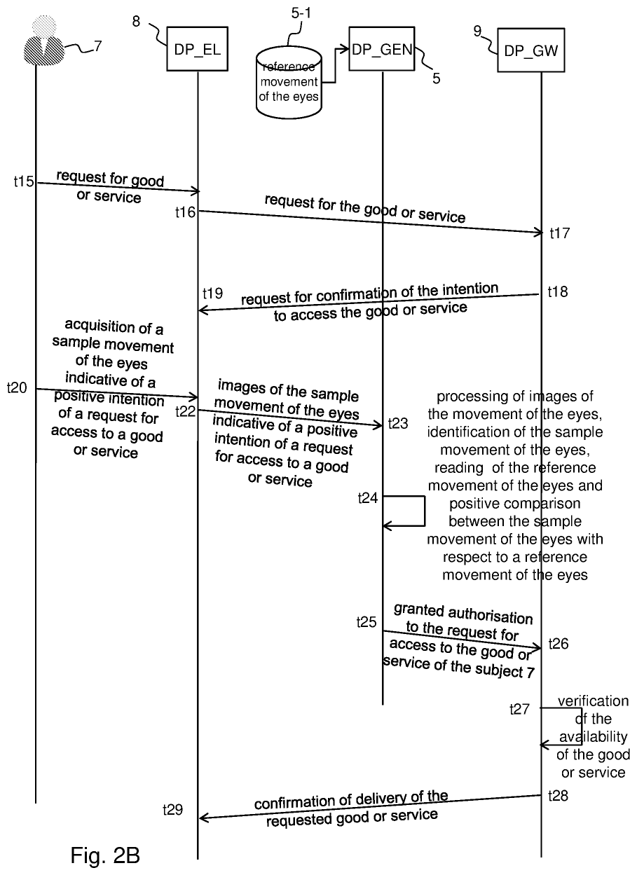

With reference to FIGS. 2A-2B, a time trend of the messages exchanged among the different components of the electronic authentication system 1 according to the disclosure are shown.

FIGS. 2A-2B show how the method for authenticating a subject for access to a good or service by means of the assistance of the eyes according to the disclosure is implemented.

It can be observed that there are two time phases:
a first identification phase comprised between the initial instant to and the instant t14, wherein the subject 7 is identified by means of the assistance of the eyes;
a second confirmation phase comprised between the instant t15 and the instant t30, wherein an action is performed to confirm the intention of a request for access to the account.

For the sake of simplicity, it is assumed that the electronic device 8 is a smartphone provided with an integrated front camera 2 and that the service requested is the access to the balance of a account of the bank 9.

It is also assumed that in the second phase a sample movement of the eyes is used to confirm the intention of the request for access to the bank account, wherein said sample movement of the eyes is a movement of the pupil upwards followed by a movement of the pupil downwards; in this case identification data of the reference movement of the eyes are stored, i.e., a movement of the pupil upwards followed by a movement of the pupil downwards, in the memory 5-1 associated to the generation/authorisation server device 5.

Furthermore, it is assumed that in the memory 6-1 associated to the authentication server device 6, identification data of the reference ocular code are stored, which is assumed have been generated by means of a suitable mathematical algorithm which takes as input the colour of the sclera, the colour of the iris and the diameter of the eyes of the subject 7.

At the initial instant to a plurality of images representative of at least one portion of the face of the subject 7 are acquired by means of a camera 2 of the smartphone 8, wherein said portion of the face comprises the eyes of the subject 7.

At the instant t1 the smartphone 8 transmits, towards the generation/authorisation server device 5, the plurality of acquired images representative of at least one portion of the face comprising the eyes of the subject 7.

At the instant t2 (following t3) the generation/authorisation server device 5 receives from the smartphone 8 the acquired images representative of at least one portion of the face comprising the eyes, then the processing unit of the generation/authorisation server device 5 performs an appropriate processing of the acquired images and identifies ocular biometric parameters of the subject 7.

In particular, the ocular biometric parameters identified are as follows:
colour of the sclera of the eyes of the subject 7;
colour of the iris of the eyes of the subject 7;
diameter of the eyes of the subject 7.

Subsequently, the processing unit of the generation/authorisation server device 5 generates, as a function of the three identified ocular biometric parameters, a unique sample ocular code associated to the ocular biometric parameters; in particular, said sample ocular code is stored in the non-volatile memory 5-1 internal or external to the generation/authorisation server device 5.

In particular, the processing unit of the generation/authorisation server device 5 extracts from the received images the three ocular biometric parameters which are the colour of the sclera of the eyes of the subject 7, the colour of the iris of the eyes of the subject 7 and the diameter of the eyes of the subject 7, then the processing unit of the generation/authorisation server device 5 generates the sample ocular code by means of a suitable algorithm (i.e., a suitable function) which takes as input the three ocular biometric parameters of the colour of the sclera of the eyes of the subject 7, colour of the iris of the eyes of the subject 7 and diameter of the eyes of the subject 7.

Subsequent to the instant t4, the generation/authorisation server device 5 transmits, towards the authentication server device 6, a message carrying data representative of the sample ocular code of the subject 7.

At the instant t5 (following t4) the authentication server device 6 receives the data representative of the sample ocular code and at the instant t6 it reads, from the non-volatile memory 6-1 internal or external to the authentication server device 6, the value of the reference ocular code of the subject 7.

Subsequent to the instant t7, the processing unit of the authentication server device 6 performs a comparison between the value of the sample ocular code and the value of the reference ocular code and detects that the value of the sample ocular code is equal to the value of the reference ocular code: in this case, at the instant t10 (following t7), the authentication server device 6 transmits, towards the generation/authorisation server device 5, a message representative of a positive confirmation of the identity of the subject 7.

At the instant t11, the generation/authorisation server device 5 receives said positive confirmation of the identity of the subject 7, then at the instant t12 the generation/authorisation server device 5 transmits towards the smartphone 8 a message indicative of a performed verification of the identity of the subject 7.

It should be noted that the message transmitted at instant t12 is indicative of the fact that the verification of the identity of the subject 7 has been performed, without specifying whether such a verification has been positive or negative: this latter information is available only to the generation/authorisation server device 5 and thereby the confidentiality of the ocular biometric profile of the subject 7 is preserved.

At the instant t13 (following t12) the smartphone 8 receives the message indicative of the performed verification of the identity of the subject 7, such as a text and/or graphic message which is displayed on the screen 3 of the smartphone 8, then the first phase ends at the instant t13.

In the instant t15 the second confirmation phase begins.

At the instant t15, the smartphone 8 receives from the subject 7 a request for access to the balance of the bank account of the subject 7, then at the instant t16, the smartphone 8 transmits towards the bank 9 a message indicative of the request for access to the balance of his/her bank account.

At the instant t17 the bank 9 receives the request for access to the balance of his/her bank account and it is verified that the subject 7 has opened an account at the bank 9; subsequent to the instant t18 the bank 9 transmits towards the smartphone 8 a message indicative of a request for confirmation of the intention to access the balance of the bank account of the subject 7.

At the instant t19 the smartphone 8 receives from the bank 9 the request for confirmation of the intention to access the balance of the bank account, then at the instant t20 the subject 7 confirms his/her intention to access the balance of his/her bank account at the bank 9.

In particular, said confirmation of intention to access the balance is implemented at instant t20 by the subject 7 by means of a particular movement of the eyes defined in advance, which consists of a movement of the pupil upwards followed by a movement of the pupil downwards, defined below by “sample movement of the eyes”.

Therefore at the instant t20 the smartphone 8 acquires, by means of its camera, a plurality of images representative of said sample movement of the eyes, wherein said sample movement is indicative of a positive intention of the request for access to the balance of the bank account.

At the instant t22, the smartphone transmits towards the generation/authorisation server device 5 a message carrying the plurality of images representative of the sample movement of the eyes indicative of the positive intention of the request for access to the balance of the bank account.

At the instant t23 the generation/authorisation server device 5 receives the plurality of images representative of the movement of the eyes, then at the instant t24 the processing unit of the generation/authorisation server device 5 performs a processing of the received images and detects that the sample movement of the eyes is a movement of the pupil upwards followed by a movement of the pupil downwards.

Subsequently, the processing unit of the generation/authorisation server device 5 reads from the memory 5-1 data representative of the reference movement of the eyes which consists of a movement of the pupil upwards followed by a movement of the pupil downwards, performs the comparison between the sample movement of the eyes (i.e., real-time movement of the pupil upwards followed by a movement of the pupil downwards) and the reference movement of the eyes (i.e., predefined movement of the pupil upwards followed by a movement of the pupil downwards) and detects that the sample movement of the eyes is equal to the reference movement of the eyes: in this case, at the instant t25 the generation/authorisation server device 5 transmits towards the bank 9 a message indicative of an authorisation granted to the request for access to the balance of the bank account of the subject 7.

At the instant t26, the bank 9 receives the message indicative of an authorisation granted to the request for access to the balance of the bank account, then it is verified that the balance of the bank account is available.

At the instant t28 the bank 9 transmits towards the smartphone 8 a message indicative of the balance of the bank account of the subject 7.

At the instant t29, the smartphone 8 receives the balance of his/her bank account.

In one embodiment, an asymmetric encryption (i.e., which uses a public and a private key) is used to protect the sample ocular code transmitted from the electronic device 8 to the generation/authorisation server device 5 and to protect the reference ocular code transmitted by the authentication server device 6 and the generation/authorisation server device 5.

According to a variant of the disclosure, in the second confirmation phase, in addition to the defined movement of the eyes, a blinking of the eyes of the subject 7 is also used.

In one embodiment, in the second confirmation phase, in addition to the movement of the eyes, a movement of the head is also used, in particular a tilting of the head (to the right or to the left) or a rotation of the head (clockwise or counterclockwise).

Let's consider for example a tilting movement of the head to the right, in this case the operation of the second phase is modified as follows:
at the instant t20 the smartphone 8 acquires, by means of its camera, a first plurality of images representative of a sample movement of the eyes of the subject 7 and a second plurality of images representative of a sample movement of the head of the subject 7 which consists of a tilting of the head to the right, wherein said sample movement is indicative of a positive intention of the request for access to the balance of the bank account and wherein said sample movement of the head (tilting to the right) is indicative of a positive intention of the request for access to the balance of the bank account;
at the instant t22 the smartphone 8 transmits towards the generation/authorisation server device 5 a message carrying the first plurality of images representative of the sample movement of the eyes and carrying the second plurality of images representative of the sample movement of the head (tilting to the right), wherein the set of the sample movement of the eyes and of the head are indicative of the positive intention of the request for access to the balance of the bank account;
at the instant t23 the generation/authorisation server device 5 receives the first plurality of images representative of the movement of the eyes and the second plurality of images representative of the sample movement of the head, then at the instant t24 the processing unit of the generation/authorisation server device 5 performs a processing of the first and second received images and detects that the sample movement of the eyes is a movement of the pupil upwards followed by a movement of the pupil downwards and further detects that the movement of the head is a tilting of the head to the right;
subsequently, the processing unit of the generation/authorisation server device 5 reads from the memory 5-1 data representative of the reference movement of the eyes which consists of a movement of the pupil upwards followed by a movement of the pupil downwards, reads from the memory 5-1 data representative of the reference movement of the head which consists of a tilting of the head to the right, performs the comparison between the sample movement of the eyes (i.e., real-time movement of the pupil upwards followed by a movement of the pupil downwards) and the reference movement of the eyes (i.e., predefined movement of the pupil upwards followed by a movement of the pupil downwards) and detects that the sample movement of the eyes is equal to the reference movement of the eyes, and further performs a comparison between the sample movement of the head (i.e., real-time movement of the tilting of the head to the right) and the reference movement of the head (i.e., predefined movement of the tilting of the head to the right) and detects that the sample movement of the head is equal to the reference movement of the head;
at the instant t25, the generation/authorisation server device 5 transmits towards the bank 9 a message indicative of an authorisation granted to the request for access to the balance of the bank account of the subject 7.

It should be noted that the disclosure is applicable not only to enable the payment for a good or service by means of the assistance of the eyes, but more in general it can be used to control an electro-mechanical actuator by means of ocular commands, for example to control the opening of an access door, the opening of an automatic gate, the ignition of a motor vehicle.

In one embodiment, a sample/reference voice profile of the subject 7 is used in addition to the sample/reference ocular code of the subject 7, in order to further increase the security level of the authentication of the subject 7.

In this case, during the profiling procedure a reference voice profile of the subject 7 is generated, in addition to the reference ocular code of the subject 7; also during the real-time operation the sample voice profile of the subject 7 is generated, in addition to the generation of the sample ocular code.

It should also be noted that for the purposes of explanation of the disclosure, the authentication procedure has been divided into two phases, but such a division is not essential, i.e., it is also possible to implement it so that the messages exchanged during the second phase overlap at least in part with the messages exchanged during the first phase.

According to an embodiment of the disclosure, the reference ocular code is divided into two parts, wherein a first part is stored in a memory associated to the authentication server device 6 and a second part is associated to the gateway device 9, similar to what is illustrated for the reference voice profile divided into two portions stored in two separate memories associated to the devices 6 and 9, as described in PCT patent application no. PCT/IB2021/055428 claiming priority of Italian patent application no. 102020000015973 in the name of the same Applicant.

1-15. (canceled)

16. A method implemented by means of at least one computer for authenticating a subject for access to a good or service, the method comprising steps of:
a) acquiring, at an electronic device, a plurality of images representative of at least one portion of a face comprising eyes of a subject;
b) transmitting, from the electronic device towards a generation/authorization server device, said plurality of acquired images;
c) receiving, at the generation/authorization server device, said plurality of acquired images and identifying therefrom at least one ocular biometric parameter of the subject, said biometric parameter comprising at least one from a colour of an iris, a colour of a sclera and a diameter of eyes of the subject;
d) generating, at the generation/authorization server device and as a function of the at least one ocular biometric parameter, a unique sample ocular code representative of a digital identity of the subject;
e) transmitting, from the generation/authorization server device towards an authentication server device, a message carrying data representative of the sample ocular code of the subject;
f) receiving, at the authentication server device, the data representative of the sample ocular code of the subject and reading, from a memory associated to the authentication server device, a value of a reference ocular code representative of a digital identity of the subject;
g) comparing, at the authentication server device, the value of the sample ocular code with respect to the value of the reference ocular code and detecting that they are equal;
h) transmitting, from the authentication server device towards the generation/authorization server device, a message representative of a positive confirmation of the identity of the subject;
i) receiving, at the generation/authorization server device, said positive confirmation of the identity of the subject and transmitting, towards the electronic device, a message indicative of a performed verification of the identity of the subject;
j) receiving, at the electronic device, the message indicative of the performed verification of the identity and transmitting, towards a gateway device, a message indicative of a request for the good or service;
k) receiving, at the gateway device, the request for the good or service and transmitting, towards the electronic device, a message indicative of a request for confirmation of an intention to access the good or service;
l) receiving, at the electronic device, the confirmation request of the intention to access the good or service and acquiring a plurality of images representative of a movement of the eyes of the subject, wherein said movement of the eyes is indicative of a positive or negative intention of the request for access to the good or service requested;
m) transmitting, from the electronic device towards the generation/authorization server device, a message carrying the plurality of images representative of the movement of the eyes of the subject;
n) receiving, at the generation/authorization server device, the plurality of images representative of the movement of the eyes of the subject, processing said plurality of images received and identifying therefrom the movement of the eyes indicative of a positive intention of the request for access to the requested good or service; and
o) transmitting, from the generation/authorization server device towards the gateway device, a message indicative of an authorization granted to the request for access to the requested good or service.

17. The method according to claim 16, wherein:
step l) comprises acquiring a further plurality of images representative of a movement of a head of the subject, the movement including a tilting of the head or a rotation of the head, wherein said movement of the head is indicative of a positive or negative intention of the request for access to the requested good or service;
step n) comprises receiving the further plurality of images representative of the movement of the head, processing the further plurality of images and identifying, as a function of the plurality of images and the further plurality of images, the movement of the head indicative of a positive intention of the request for access to the requested good or service.

18. The method according to claim 16, wherein step c) comprises identifying at least three biometric parameters comprising the colour of the iris, the colour of the sclera and the diameter of the eyes of the subject.

19. The method according to claim 16, wherein:
step l) comprises acquiring a further plurality of images representative of a blinking of the eyes of the subject, wherein said blinking is indicative of a positive intention of the request for access to the requested good or service; and
step n) comprises receiving the further plurality of images representative of the blinking of the eyes of the subject, processing the further plurality of images and identifying, as a function of the plurality of images and the further plurality of images, the movement of a head of the subject indicative of a positive intention of the request for access to the requested good or service.

20. The method according claim 16, wherein in step n) the identified movement of the eyes indicative of a positive intention of the request for access to the good or service requested is selected from the following:
moving the eyes towards a right-side edge or towards a left-side edge of a screen observed by the subject; and
tracking with the eyes a light signal moving along a screen observed by the subject.

21. The method according to claim 16, wherein:
step l) comprises acquiring, at the electronic device, a plurality of images representative of a sample movement of the eyes,
step m) comprises transmitting the message carrying the plurality of images representative of the sample movement of the eyes, and
step n) comprises:
receiving, at the generation/authorization server device, the plurality of images representative of the sample movement of the eyes;
analysing the plurality of received images and identifying therefrom the sample movement of the eyes;
reading, from a memory associated to the generation/authorization server device, data indicative of a reference movement of the eyes;
comparing, at the generation/authorization server device, the identified sample movement of the eyes with respect to the data indicative of a reference movement of the eyes; and
transmitting, from the generation/authorization server device to the gateway device, a message indicative of an authorization granted or denied to the request for access to the requested good or service, as a function of said comparison.

22. The method according to claim 21, wherein the sample and reference movements of the eyes are selected from the following:
a movement of a pupil upwards or downwards;
a movement of the pupil upwards followed by a movement of the pupil downwards, or vice versa;
a movement of the pupil to the right or to the left; and
a movement of the pupil to the right followed by a movement of the pupil to the left, or vice versa.

23. The method according to claim 16, wherein:
step a) further comprises acquiring a sample voiceprint representative of a defined phrase pronounced by the subject;
step b) comprises further transmitting the acquired sample voiceprint;
step c) comprises further generating, at the generation/authorization server device and as a function of the acquired sample voiceprint, a sample voice profile of the subject; and
step e) comprises transmitting the message further carrying data representative of the sample voice profile;
step f) comprises further receiving the data representative of the sample voice profile and reading, from the memory associated to the authentication server device, a value of a reference voice profile representative of a digital identity of the subject;
step g) further comprises comparing the value of the sample voice profile with respect to the value of the reference voice profile and detecting that they are equal.

24. The method according to claim 16, further comprising, after step o), step p) of receiving, at the gateway device, the message indicative of the granted authorization, verifying availability of the good or service and transmitting, from the gateway device to the electronic device, a message indicative of a confirmation or a refusal for a delivery of the good or service.

25. A non-transitory computer-readable storage medium having a program comprising portions of software code adapted to perform the steps of the method according to claim 16, when said program is run on at least one computer.

26. An electronic system to authenticate a subject, the system comprising an electronic device, a generation/authorization server device connected to the electronic device by means of a medium-long distance telecommunications network, an authentication server device connected to the generation/authorization server device by means of the telecommunications network, and a gateway device connected to the generation/authorization server device by means of the telecommunications network and further connected to the electronic device,
wherein the electronic device is configured to:
acquire a plurality of images representative of at least one portion of a face comprising eyes of a subject;
transmit, towards the generation/authorization server device, said plurality of acquired images;
receive a message indicative of a performed verification of a digital identity of the subject and transmit, towards the gateway device, a message indicative of a request for a good or service;
receive a request for confirmation of an intention to access the good or service and acquire a plurality of images representative of a movement of the eyes of the subject, wherein said movement is indicative of a positive or negative intention of the request for access to the requested good or service;
transmit, towards the generation/authorization server device, a message carrying the plurality of images representative of the movement of the eyes of the subject;
wherein the generation/authorization server device is configured to:
receive, at the generation/authorization server device, said plurality of acquired images and identify therefrom at least one ocular biometric parameter of the subject, said biometric parameter comprising at least one from a colour of an iris, a colour of a sclera and a diameter of the eyes of the subject;
generate, as a function of the at least one ocular biometric parameter, a unique sample ocular code representative of a digital identity of the subject;
transmit, towards the authentication server device, a message carrying data representative of the sample ocular code of the subject;
receive a positive confirmation of the identity of the subject and transmit, towards the electronic device, a message indicative of the performed verification of the identity of the subject;
receive the plurality of images representative of the movement of the eyes of the subject, process said plurality of images received and identify therefrom the movement indicative of a positive intention of the request for access to the requested good or service;
transmit, towards the gateway device, a message indicative of an authorization granted to the request for access to the requested good or service;
wherein the authentication server device is configured to:
receive data representative of the sample ocular code of the subject and read, from a memory associated to the authentication server device, a value of a reference ocular code representative of a digital identity of the subject;
compare the value of the sample ocular code with respect to the value of the reference ocular code and detect that they are identical;
transmit, towards the generation/authorization server device, a message representative of a positive confirmation of the identity of the subject;
and wherein the gateway device is configured to receive the request for the good or service and transmit, towards the electronic device, a message indicative of a request for confirmation of the intention to access the good or service.

27. The electronic system according to claim 26,
wherein the electronic device is configured to:
receive the request for confirmation of the intention to access the good or service and acquire a further plurality of images representative of a movement of a head of the subject, in particular a tilting of the head or a rotation of the head, wherein said movement of the head is indicative of a positive or negative intention of the request for access to the requested good or service;
transmit, towards the generation/authorization server device, the message carrying the further plurality of images representative of the movement of the eyes of the subject;
and wherein the generation/authorization server device is configured to:
receive the further plurality of images representative of the movement of the head of the subject, process the further plurality of images and identify, as a function of the plurality of images and of the further plurality of images, the movement of the head indicative of the positive intention of the request for access to the requested good or service.

28. The electronic system according to claim 26, wherein the generation/authorization server device is configured to identify at least three biometric parameters comprising the colour of the iris, the colour of the sclera and the diameter of the eyes of the subject.

29. The electronic system according to claim 26, wherein the identified movement of the eyes indicative of the positive intention of the request for access to the requested good or service is selected from the following:
moving the eyes towards a right-side edge or towards a left-side edge of a screen observed by the subject;
tracking with the eyes a light signal moving along a screen observed by the subject.

30. The electronic system according to claim 26,
wherein the electronic device is further configured to:
acquire a plurality of images representative of a sample movement of the eyes;
transmit, towards the generation/authorization server device, a message carrying the plurality of images representative of the sample movement of the eyes;
and wherein the generation/authorization server device is configured to:
receive, at the generation/authorization server device, the plurality of images representative of the sample movement of the eyes;
analyse the plurality of received images and identify therefrom the sample movement of the eyes;
read, from a memory associated to the generation/authorization server device, data indicative of a reference movement of the eyes;
compare the identified sample movement of the eyes with respect to the data indicative of a reference movement of the eyes;
transmit, from the generation/authorization server device to the gateway device, a message indicative of an authorization granted or denied to the request for access to the requested good or service, as a function of said comparison.

31. The method according to claim 17, wherein step c) comprises identifying at least three biometric parameters comprising the colour of the iris, the colour of the sclera and the diameter of the eyes of the subject.

32. The method according to claim 17, wherein:
step l) comprises acquiring a further plurality of images representative of a blinking of the eyes of the subject, wherein said blinking is indicative of a positive intention of the request for access to the requested good or service;
step n) comprises receiving the further plurality of images representative of the blinking of the eyes of the subject, processing the further plurality of images and identifying, as a function of the plurality of images and the further plurality of images, the movement of the head indicative of a positive intention of the request for access to the requested good or service.

33. The electronic system according to claim 27, wherein the generation/authorization server device is configured to identify at least three biometric parameters comprising the colour of the iris, the colour of the sclera and the diameter of the eyes of the subject.

34. The electronic system according to claim 27, wherein the identified movement of the eyes indicative of the positive intention of the request for access to the requested good or service is selected from the following:
moving the eyes towards a right-side edge or towards a left-side edge of a screen observed by the subject;
tracking with the eyes a light signal moving along a screen observed by the subject.
